(19) United States
(12) Patent Application Publication
(10) Pub. No.: US 2019/0165439 A1
(43) Pub. Date: May 30, 2019

(54) FUEL CELL SYSTEM AND CONTROL METHOD FOR FUEL CELL SYSTEM

(71) Applicant: TOYOTA JIDOSHA KABUSHIKI KAISHA, Toyota-shi (JP)

(72) Inventor: Haruka HIROSE, Toyota-shi (JP)

(73) Assignee: TOYOTA JIDOSHA KABUSHIKI KAISHA, Toyota-shi (JP)

(21) Appl. No.: 16/157,645

(22) Filed: Oct. 11, 2018

(30) Foreign Application Priority Data
Nov. 28, 2017 (JP) 2017-227356

(51) Int. Cl. H01M 16/00; H01M 8/04537; H01M 8/0432; H01M 8/04858; H01M 8/04828; H01M 10/48

(52) U.S. Cl. CPC H01M 16/006; H01M 8/04626; H01M 8/04373; H01M 10/48; H01M 8/04873; H01M 8/04932; H01M 8/04947; H01M 8/04888

(57) ABSTRACT

A fuel cell system includes a control unit configured to control for switching a secondary battery step-up converter between a step-up operation mode and a step-up stop mode. The control unit is configured to obtain a correlation value that correlates with a dischargeable electric power of a secondary battery, prohibit the step-up stop mode when a required voltage of a load is lower than an output voltage of the secondary battery and the correlation value falls within a prohibition range in which the step-up stop mode is prohibited, and execute the step-up stop mode when the required voltage is lower than the output voltage of the secondary battery and the correlation value falls outside the prohibition range.

### INCORPORATION BY REFERENCE

The disclosure of Japanese Patent Application No. 2017-227356 filed on Nov. 28, 2017 including the specification, drawings and abstract is incorporated herein by reference in its entirety.

### BACKGROUND

### 1. Technical Field

The disclosure relates to a fuel cell system and a control method for a fuel cell system.

### 2. Description of Related Art

Conventionally, there is known a fuel cell system. In the fuel cell system, a fuel cell and a secondary battery are connected to a load, such as a drive motor, in parallel with each other, a step-up converter is provided between the fuel cell and the drive motor, and a step-up converter is provided between the secondary battery and the drive motor. In a fuel cell system described in Japanese Unexamined Patent Application Publication No. 2016-092893 (JP 2016-092893 A), when a required voltage of a drive motor is lower than a fuel cell voltage or a secondary battery voltage, a loss is reduced by stopping each step-up converter, thus reducing electric power consumption.

### SUMMARY

In a configuration of adjusting the output electric power of a fuel cell by changing the duty ratio of a switching element of a fuel cell step-up converter, when a required voltage of a drive motor has rapidly increased while a secondary battery step-up converter is stopped, adjustment of the output electric power of the fuel cell possibly cannot keep pace with the rapid increase in the required voltage of the drive motor. Since a shortage of electric power at this time is supplied from the secondary battery side, when the required voltage is compensated from the secondary battery while the secondary battery step-up converter is stopped, an overdischarge of the secondary battery can occur, and a secondary battery voltage can rapidly drop. Since a secondary-side voltage of the fuel cell step-up converter and a secondary-side voltage of the secondary battery step-up converter are equal to each other, when the secondary battery voltage drops to the fuel cell voltage from a state where the secondary battery voltage is higher than the fuel cell voltage while the secondary battery step-up converter is stopped, a primary-side voltage of the fuel cell step-up converter and the secondary-side voltage of the fuel cell step-up converter are equal to each other. For this reason, it is not possible to cause the fuel cell step-up converter to perform step-up operation, with the result that the fuel cell step-up converter, stops. In the configuration of adjusting the output electric power of the fuel cell with the fuel cell step-up converter, if the fuel cell step-up converter stops, it is not possible to adjust output electric power, with the result that a required voltage of a load possibly cannot be supplied. On the other hand, if an electric power higher than or equal to a rated dischargeable electric power continues to be supplied from the secondary battery by causing the secondary battery side to supply a shortage of electric power, the secondary battery can possibly degrade. For this reason, in a fuel cell system that adjusts output electric power with a fuel cell step-up converter, there is a need for a technique for reducing electric power consumption while avoiding as much as possible a situation in which the fuel cell step-up converter stops and the output electric power is not adjustable.

The disclosure is able to implement the following aspects.

A first aspect of the disclosure relates to a fuel cell system. The fuel cell system includes a fuel cell, a secondary battery, a fuel cell step-up converter, a secondary battery step-up converter, and a control unit. The fuel cell is configured to supply an electric power to a load. The secondary battery is configured to supply an electric power to the load. The fuel cell step-up converter is connected between the fuel cell and the load. The fuel cell step-up converter is configured to step up an output voltage of the fuel cell. The fuel cell step-up converter is configured to adjust an output electric power of the fuel cell. The secondary battery step-up converter is connected between the secondary battery and the load. An output terminal of the secondary battery step-up converter and an output terminal of the fuel cell step-up converter are electrically connected to each other. The secondary battery step-up converter is configured to step up an output voltage of the secondary battery. The control unit is configured to execute control for adjusting the output electric power with the fuel cell step-up converter and control for switching the secondary battery step-up converter between a step-up operation mode and a step-up stop mode. The control unit is configured to obtain a correlation value that correlates with a dischargeable electric power of the secondary battery. The control unit is configured to, when a required voltage of the load is lower than the output voltage of the secondary battery and the obtained correlation value falls within a predetermined prohibition range in which the step-up stop mode is prohibited, prohibit the step-up stop mode of the secondary battery step-up converter. The control unit is configured to, when the required voltage is lower than the output voltage of the secondary battery and the obtained correlation value falls outside the prohibition range, execute the step-up stop mode. With the fuel cell system according to the first aspect, the correlation value that correlates with the dischargeable electric power of the secondary battery is obtained, and the step-up stop mode is prohibited when the obtained correlation value falls within the prohibition range in which the step-up stop mode is prohibited even when the required voltage is lower than the output voltage of the secondary battery. Thus, it is possible to prohibit the step-up stop mode when there is a possibility of an overdischarge of the secondary battery. For this reason, when the required voltage of the load has rapidly increased, it is possible to avoid as much as possible a rapid drop of the secondary battery voltage resulting from an overdischarge of the secondary battery due to the step-up stop mode of the secondary battery step-up converter. Therefore, it is possible to avoid as much as possible a situation in which the primary-side voltage and secondary-side voltage of the fuel cell step-up converter are equal to each other, so it is possible to avoid as much as possible a stop of the fuel cell step-up converter. In this way, with the fuel cell system according to the above aspect, it is possible to reduce electric power consumption while avoiding as much as possible a situation in which the output electric power is not adjustable by the fuel cell step-up converter.

In the fuel cell system, the control unit may be configured to, when the obtained correlation value falls within a predetermined permission range that is different from the prohibition range and in which the step-up stop mode is permitted while the step-up stop mode is prohibited, cancel the prohibition of the step-up stop mode. With the fuel cell system according to this aspect, since the prohibition of the step-up stop mode is cancelled at the time when the obtained correlation value falls within the permission range, it is possible to further reduce electric power consumption of the secondary battery step-up converter by permitting the step-up stop mode of the secondary battery step-up converter when there is a low possibility of an overdischarge of the secondary battery, and it is possible to further reduce a loss in the load, and the like. Therefore, it is possible to further reduce the total electric power consumption of the fuel cell system.

The fuel cell system may further include at least one of a temperature sensor configured to detect a temperature of the secondary battery and an SOC detection unit configured to detect an amount of electric power stored in the secondary battery, and the control unit may be configured to obtain the correlation value with at least one of the detected temperature and the detected amount of electric power stored. With the fuel cell system according to this aspect, since the correlation value is obtained with at least one of the secondary battery temperature and the amount of electric power stored, which significantly influence the dischargeable electric power, it is possible to suppress a decrease in correlativity between the correlation value and the dischargeable electric power of the secondary battery. Alternatively, the control unit may be configured to obtain the correlation value with both the detected temperature and the detected amount of electric power stored. Alternatively, the control unit may be configured to, when the temperature of the secondary battery is higher than a first predetermined value or lower than a second predetermined value or when the amount of electric power stored is lower than a predetermined value, prohibit the step-up stop mode.

In the fuel cell system, the correlation value may be a dischargeable electric power value of the secondary battery. With the fuel cell system according to this aspect, since a dischargeable electric power value that is directly related to an overdischarge of the secondary battery is used as the correlation value, it is possible to prohibit the step-up stop mode in accurately keeping with the dischargeable electric power of the secondary battery. In addition, the control unit may store a prohibition threshold of a dischargeable electric power value for prohibiting the step-up stop mode of the secondary battery step-up converter and a permission threshold of the dischargeable electric power value for permitting the step-up stop mode. Furthermore, the permission threshold may be set so as to be higher than the prohibition threshold.

A second aspect of the disclosure relates to a control method for a fuel cell system. The control method includes: obtaining a correlation value that correlates with a dischargeable electric power of a secondary battery; when a required voltage of a load, to which an electric power is supplied from the secondary battery and a fuel cell, is lower than an output voltage of the secondary battery and the obtained correlation value falls within a predetermined prohibition range in which a step-up stop mode of a secondary battery step-up converter is prohibited, prohibiting the step-up stop mode, the secondary battery step-up converter being connected between the secondary battery and the load, an output terminal of the secondary battery step-up converter and an output terminal of a fuel cell step-up converter being electrically connected to each other, the secondary battery step-up converter being configured to step up the output voltage of the secondary battery, the fuel cell step-up converter being connected between the fuel cell and the load, the fuel cell step-up converter being configured to step up an output voltage of the fuel cell, the fuel cell step-up converter being configured to adjust an output electric power of the fuel cell; and, when the required voltage is lower than the output voltage of the secondary battery and the obtained correlation value falls outside the prohibition range, executing the step-up stop mode of the secondary battery step-up converter.

The disclosure may be implemented in various forms other than the fuel cell system. For example, the disclosure may be implemented in forms, such as a control method for a fuel cell system and a vehicle including a fuel cell system.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic diagram that shows an electric system of a fuel cell system;

FIG. 2 is a flowchart that shows the procedure of step-up stop control;

FIG. 3 is a graph that illustrates an example of the relation between a secondary battery temperature and a dischargeable electric power;

FIG. 4 is a graph that illustrates an example of the relation between an SOC and a dischargeable electric power;

FIG. 5 shows graphs that illustrate an example of a variation in voltage of a secondary battery and a change of a flag; and

FIG. 6 is a graph that illustrates an example of a voltage drop of a secondary battery in a comparative example.

### DETAILED DESCRIPTION OF EMBODIMENTS

### A. First Embodiment

### A-1. Configuration of Fuel Cell System

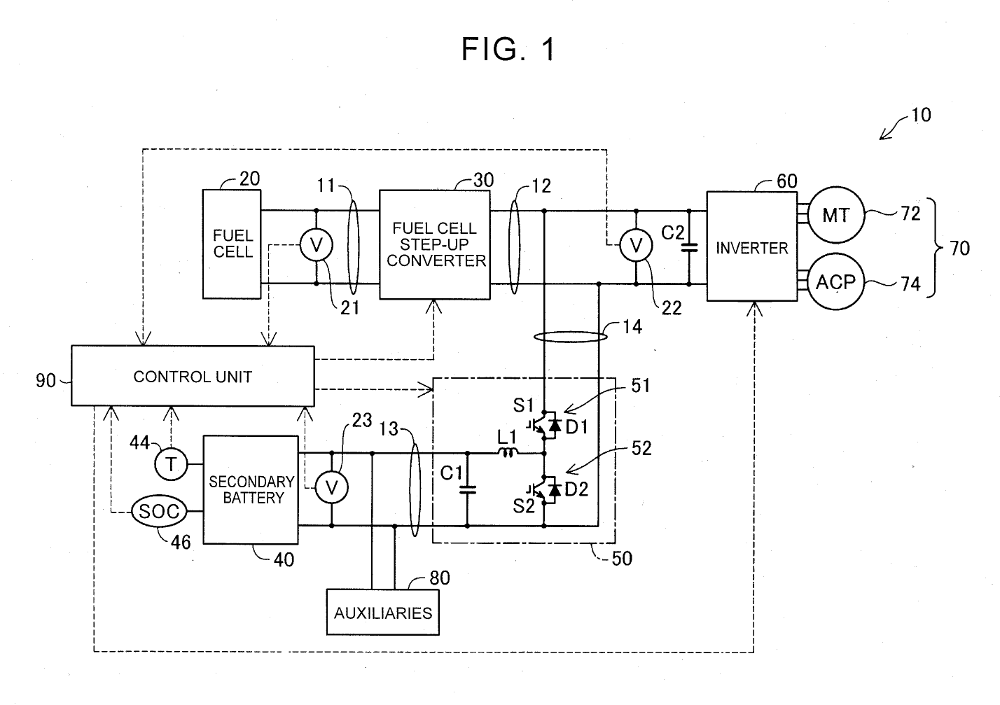

FIG. 1 is a schematic diagram that shows an electric system of a fuel cell system according to an embodiment of the disclosure. The fuel cell system 10 is mounted on a fuel cell vehicle (not shown) as a system for supplying a driving power.

The fuel cell system 10 includes a fuel cell 20, a fuel cell step-up converter 30, a secondary battery 40, a secondary battery temperature sensor 44, an SOC detection unit 46, a secondary battery step-up converter 50, an inverter 60, loads 70, auxiliaries 80, and a control unit 90.

The fuel cell 20 is a power source of the fuel cell system 10, and is a so-called solid polymer electrolyte fuel cell. The fuel cell 20 generates an electric power when supplied with fuel gas and oxidant gas. The fuel cell 20 may be a fuel cell of any other type, such as a solid oxide fuel cell, instead of a solid polymer electrolyte fuel cell. The fuel cell 20 is connected to the input terminal of the fuel cell step-up converter 30 via first lines 11. A first voltage sensor 21 is connected to the output terminal of the fuel cell 20. The first voltage sensor 21 measures the output voltage of the fuel cell 20. The first voltage sensor 21 outputs a signal to the control unit 90. The signal indicates the output voltage of the fuel cell 20.

The fuel cell step-up converter 30 steps up the output voltage of the fuel cell 20 in response to a command from the control unit 90. In other words, the fuel cell step-up converter 30 steps up a primary-side voltage of the fuel cell step-up converter 30 to a secondary-side voltage of the fuel cell step-up converter 30. The primary side means a side to which an electric power is supplied, that is, an input side. The secondary side means a side from which an electric power is supplied, that is, an output side. A stepped-up voltage is supplied to the inverter 60 via second lines 12. The fuel cell step-up converter 30 adjusts the output electric power of the fuel cell 20. More specifically, the amount of current passing through the fuel cell step-up converter 30 is adjusted by changing the duty ratio of a switching circuit (not shown) of the fuel cell step-up converter 30. Thus, the output electric power of the fuel cell 20 is adjusted. As a result, the output electric power of the fuel cell system 10 is adjusted.

In the present embodiment, the fuel cell step-up converter 30 is a non-isolated DC-DC converter. The output terminal of the fuel cell step-up converter 30 is connected to the direct-current terminal of the inverter 60 via the second lines 12. A second voltage sensor 22 is connected to the second lines 12. The second voltage sensor 22 measures a voltage that is input to the inverter 60. The second voltage sensor 22 outputs a signal to the control unit 90. The signal indicates a voltage that is input to the inverter 60.

The secondary battery 40 is a lithium ion battery. The secondary battery 40 functions as a power source of the fuel cell system 10 together with the fuel cell 20. Instead of a lithium ion battery, the secondary battery 40 may be a secondary battery of any other type, such as a nickel-metal hydride battery. The secondary battery 40 is connected to the input terminal of the secondary battery step-up converter 50 via third lines 13. A third voltage sensor 23 is connected to the output terminal of the secondary battery 40. The third voltage sensor 23 measures the output voltage of the secondary battery 40. The third voltage sensor 23 outputs a signal to the control unit 90. The signal indicates the output voltage of the secondary battery 40.

In the present embodiment, the output voltage of the secondary battery 40 is higher than the output voltage of the fuel cell 20 in a normal operating state. The output voltage of the secondary battery 40 and the output voltage of the fuel cell 20 both vary and have an overlapped varying voltage range. The normal operating state means an operating state in the case where the temperature or SOC of the secondary battery 40 falls within a predetermined range and the amount of electric power generated by the fuel cell 20 falls within a predetermined range.

The secondary battery temperature sensor 44 is connected to the secondary battery 40. The secondary battery temperature sensor 44 detects the temperature of the secondary battery 40. The secondary battery temperature sensor 44 outputs a signal to the control unit 90. The signal indicates the temperature of the secondary battery 40.

The SOC detection unit 46 is connected to the secondary battery 40. The SOC detection unit 46 detects a state of charge (SOC) that indicates the amount of electric power stored in the secondary battery 40, and outputs the SOC to the control unit 90. An SOC is represented by the ratio of the remaining amount of electric power stored to the capacity of electric power stored in the secondary battery 40. In the present embodiment, an SOC is obtained by integrating a charge current and a discharge current. For example, an SOC may be obtained based on the specific gravity of secondary battery electrolyte and a secondary battery voltage.

The secondary battery step-up converter 50 steps up the output voltage of the secondary battery 40 and outputs the stepped-up output voltage to fourth lines 14 in response to a command from the control unit 90. The output terminal of the secondary battery step-up converter 50 is connected to the second lines 12 via the fourth lines 14. Therefore, the output terminal of the secondary battery step-up converter 50 is electrically connected to the output terminal of the fuel cell step-up converter 30. In the present embodiment, the secondary battery step-up converter 50 is a non-isolated DC-DC converter. The secondary battery step-up converter 50 may be a bidirectional DC-DC converter that is also able to step down a voltage that is input from the fourth lines 14 and supply the stepped-down voltage to the secondary battery 40 via the third lines 13.

The secondary battery step-up converter 50 includes an upper arm 51, a lower arm 52, a reactor L1, and a capacitor C1. The upper arm 51 includes a first switching element S1 and a first diode D1. The first switching element S1 is an insulated gate bipolar transistor (IGBT). Instead of an IGBT, the first switching element S1 may be any other switching element, such as a bipolar transistor and a MOSFET. The first diode D1 is connected to the first switching element S1 in an anti-parallel fashion. The lower arm 52 includes a second switching element S2 and a second diode D2. The lower arm 52 has a similar configuration to that of the upper arm 51. The upper arm 51 and the lower arm 52 are connected in series with each other. The reactor L1 is connected to a connection point between the upper arm 51 and the lower arm 52. The capacitor C1 is connected to the third lines 13. The capacitor C1 reduces voltage fluctuations between a positive electrode side and a negative electrode side.

The inverter 60 converts direct-current power, which is supplied from the fuel cell 20 and the secondary battery 40 via the second lines 12, to three-phase alternating-current power. The inverter 60 supplies the converted electric power to the loads 70. A capacitor C2 is connected between the inverter 60 and connection points between the second lines 12 and the fourth lines 14. The capacitor C2 reduces voltage fluctuations between a positive electrode side and a negative electrode side.

The loads 70 include a drive motor 72 and an air compressor 74. The drive motor 72 drives wheels (not shown) of the fuel cell vehicle. The air compressor 74 pumps oxidant gas to the fuel cell 20. The output torque of the drive motor 72 and the output torque of a synchronous motor of the air compressor 74 are controlled as the control unit 90 controls the inverter 60.

The auxiliaries 80 are connected to the third lines 13. The auxiliaries 80 include a hydrogen pump (not shown), a coolant pump (not shown), and the like. The hydrogen pump returns offgas, which is emitted from the fuel cell 20, to a fuel gas supply passage. The coolant pump circulates coolant that passes through the inside of the fuel cell 20.

The control unit 90 is a microcomputer including a central processing unit (CPU) and a main storage device. The control unit 90 is configured as an electronic control unit. The CPU executes a program that is prestored in the main storage device. The control unit 90 acquires voltages respectively measured by the voltage sensors 21, 22, 23, a temperature measured by the secondary battery temperature sensor 44, and an SOC detected by the SOC detection unit 46. The control unit 90 outputs control commands to the fuel cell step-up converter 30, the secondary battery step-up converter 50, and the inverter 60. The control unit 90 determines the current and voltage of the fuel cell step-up converter 30 and the current and voltage of the secondary battery step-up converter 50 for a required electric power of the loads 70. The control unit 90 executes control for adjusting the output electric power of the fuel cell 20 with the fuel cell step-up converter 30. The control unit 90 executes control for switching the secondary battery step-up converter 50 between a step-up operation mode and a step-up stop mode based on a required voltage of the loads 70, and executes step-up stop control (described later).

The step-up operation mode of the secondary battery step-up converter 50 is executed by turning on or off each of the upper arm 51 and the lower arm 52. The on state means a conductive state. The off state means a non-conductive state. A mode in which the third lines 13 and the fourth lines 14 are directly connected to each other without the step-up operation of the secondary battery step-up converter 50 is also termed as the step-up stop mode. The step-up stop mode is executed by turning on the upper arm 51 and turning off the lower arm 52. In the present embodiment, the step-up stop mode of the secondary battery step-up converter 50 is also referred to as upper arm on state for the sake of convenience.

When the required voltage of the loads 70 including the drive motor 72 is lower than a secondary battery voltage VL that is the output voltage of the secondary battery 40, the control unit 90 permits the upper arm on state of the secondary battery step-up converter 50, that is, the control unit 90 permits the step-up stop mode, as normal control. When the step-up operation of the secondary battery step-up converter 50 is stopped, electric power consumption of the secondary battery step-up converter 50 is reduced, and a loss in the loads 70 or the auxiliaries 80 is reduced, so the total electric power consumption of the fuel cell system 10 is reduced. When the step-up operation of the secondary battery step-up converter 50 is stopped, the output voltage of the secondary battery 40 and the voltage that is input to the inverter 60 are equal to each other.

Incidentally, if a slip, grip, or the like, occurs in the fuel cell vehicle, the required voltage of the loads 70, such as the drive motor 72, can rapidly increase. If such a rapid increase in the required voltage occurs, adjustment of the output electric power of the fuel cell 20 with the fuel cell step-up converter 30 possibly cannot keep pace with the rapid increase. Since a shortage of electric power at this time is supplied from the secondary battery 40 side, when the required voltage is compensated from the secondary battery 40 while the step-up operation of the secondary battery step-up converter 50 is stopped, an overdischarge of the secondary battery 40 can occur, the output voltage of the secondary battery 40 can rapidly drop, so the voltage that is input to the inverter 60 can rapidly drop.

In the present system, the output voltage of the secondary battery 40 in the normal operating state is higher than the output voltage of the fuel cell 20. Therefore, when the voltage that is input to the inverter 60 rapidly drops and becomes equal to the output voltage of the fuel cell 20, the primary-side voltage and secondary-side voltage of the fuel cell step-up converter 30 are equal to each other. As a result, it is not possible to cause the fuel cell step-up converter 30 to perform step-up operation, so the fuel cell step-up converter 30 stops. The stop of the fuel cell step-up converter 30 means that the duty ratio of the switching circuit (not shown) is fixed to zero. Since the fuel cell step-up converter 30 is used to control the output electric power of the fuel cell system 10, if the fuel cell step-up converter 30 stops, it is not possible to adjust the output electric power of the fuel cell 20, so the required voltage of the loads 70 possibly cannot be supplied. On the other hand, if an electric power higher than or equal to a rated dischargeable electric power of the secondary battery 40 continues to be supplied from the secondary battery 40 by causing the secondary battery 40 side to supply a shortage of electric power, the secondary battery 40 can possibly degrade. The fuel cell system 10 according to the present embodiment executes step-up stop control described below. Thus, when there is a possibility of a rapid voltage drop due to an overdischarge of the secondary battery 40, the step-up stop mode of the secondary battery step-up converter 50 is prohibited. Thus, the fuel cell system 10 avoids as much as possible a situation in which the primary-side voltage and secondary-side voltage of the fuel cell step-up converter 30 are equal to each other, and also avoids as much as possible a stop of the fuel cell step-up converter 30.

### A-2. Step-up Stop Control

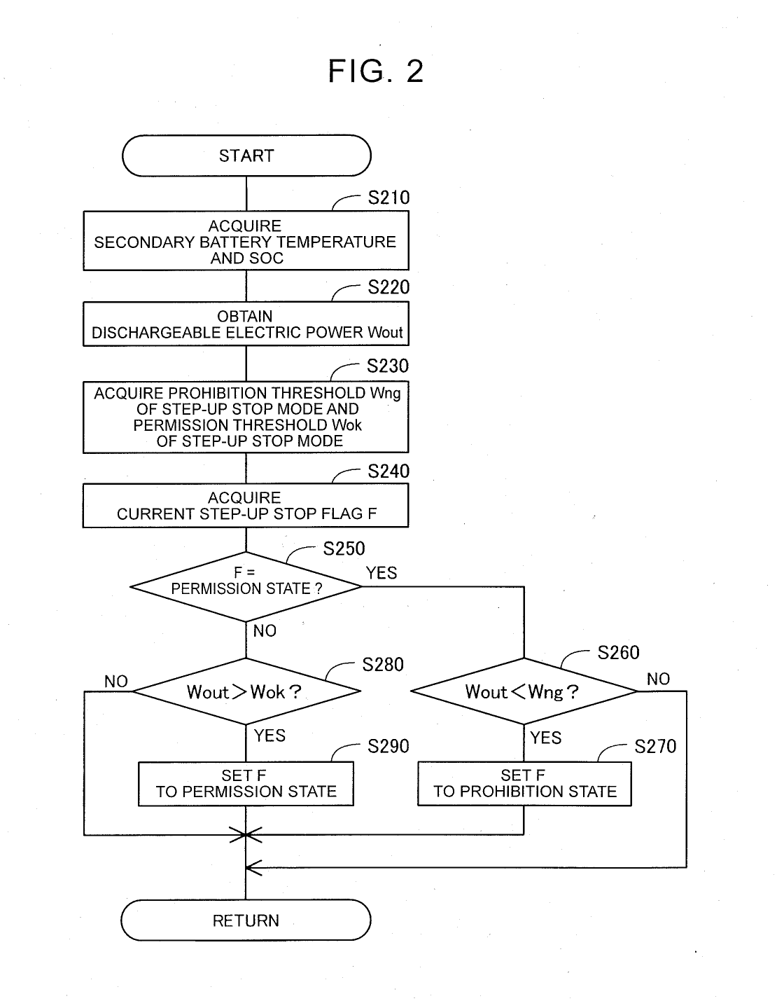

FIG. 2 is a flowchart that shows the procedure of the step-up stop control. The step-up stop control is repeatedly executed after the fuel cell system 10 starts up as a result of depressing a starter switch (not shown) of the fuel cell vehicle.

The control unit 90 acquires a secondary battery temperature detected by the secondary battery temperature sensor 44, and an SOC detected by the SOC detection unit 46 (step S210). The control unit 90 obtains a current dischargeable electric power Wout of the secondary battery 40 based on the secondary battery temperature and the SOC (step S220). The dischargeable electric power Wout depends on a secondary battery temperature, an SOC, and the like. For this reason, the relation between a dischargeable electric power Wout and a secondary battery temperature is obtained in advance by experiment, or the like, and is mapped, and the relation between a dischargeable electric power Wout and an SOC is obtained in advance by experiment, or the like, and is mapped. In step S220, the dischargeable electric power Wout is obtained based on the secondary battery temperature and the SOC by consulting these maps.

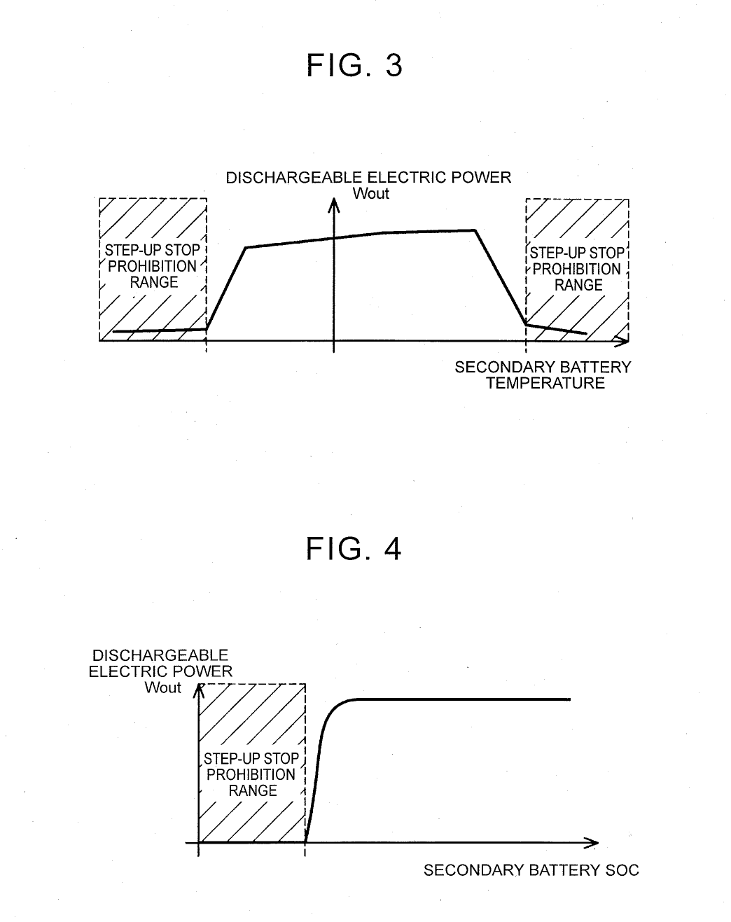

FIG. 3 is a graph that illustrates an example of the relation between a secondary battery temperature and a dischargeable electric power Wout. In FIG. 3, the ordinate axis represents a dischargeable electric power Wout of the secondary battery 40, and the abscissa axis represents a secondary battery temperature. The dischargeable electric power Wout rapidly decreases when the secondary battery temperature is higher than a predetermined value or when the secondary battery temperature is lower than a predetermined value.

FIG. 4 is a graph that illustrates an example of the relation between an SOC and a dischargeable electric power Wout. In FIG. 4, the ordinate axis represents a dischargeable electric power Wout of the secondary battery 40, and the abscissa axis represents an SOC of the secondary battery 40. The dischargeable electric power Wout rapidly decreases when the SOC is lower than a predetermined value.

While the dischargeable electric power Wout is decreasing, when the required voltage of the loads 70 has rapidly increased during the step-up stop mode of the secondary battery step-up converter 50, there is a possibility of a rapid voltage drop due to an overdischarge of the secondary battery 40. Therefore, when the dischargeable electric power Wout is low and there is a possibility of an overdischarge of the secondary battery 40, the control unit 90 prohibits the step-up stop mode of the secondary battery step-up converter 50.

In FIG. 3 and FIG. 4, examples of the range in which the step-up stop mode of the secondary battery step-up converter 50 is prohibited are hatched. In this way, when the secondary battery temperature is higher than a predetermined value or lower than a predetermined value or when the SOC is lower than a predetermined value, the dischargeable electric power Wout is low, so the step-up stop mode is prohibited.

The main storage device of the control unit 90 prestores a prohibition threshold Wng of the dischargeable electric power Wout for prohibiting the step-up stop mode of the secondary battery step-up converter 50 and a permission threshold Wok of the dischargeable electric power Wout for permitting the step-up stop mode. In the present embodiment, the permission threshold Wok is set so as to be higher than the prohibition threshold Wng from the viewpoint of reducing hunting. For example, the permission threshold Wok may be set so as to be higher by about 10 kW than the prohibition threshold Wng. The dischargeable electric power Wout in each of the step-up stop mode prohibition ranges shown in FIG. 3 and FIG. 4 is lower than the prohibition threshold Wng.

As shown in FIG. 2, the control unit 90 acquires the prohibition threshold Wng of the step-up stop mode and the permission threshold Wok of the step-up stop mode from the main storage device (step S230). The control unit 90 acquires a current step-up stop flag F from the main storage device (step S240). The step-up stop flag F has a permission state and a prohibition state. The step-up stop flag F is set to the permission state as an initial state, and is reset in step S270 and step S290 (described later).

The control unit 90 determines whether the current step-up stop flag F is the permission state (step S250). When it is determined that the current step-up stop flag F is the permission state (YES in step S250), the control unit 90 determines whether the dischargeable electric power Wout obtained in step S220 is lower than the prohibition threshold Wng (step S260). When it is determined that the dischargeable electric power Wout is lower than the prohibition threshold Wng (NO in step S260), the control unit 90 returns to step S210. In this case, the step-up stop flag F remains in the permission state.

On the other hand, when it is determined in step S260 that the dischargeable electric power Wout is lower than the prohibition threshold Wng (YES in step S260), the control unit 90 sets the step-up stop flag F to the prohibition state (step S270), and returns to step S210.

When it is determined in step S250 that the current step-up stop flag F is not the permission state (NO in step S250), that is, when the flag F is in the prohibition state, the control unit 90 determines whether the dischargeable electric power Wout obtained in step S220 is higher than the permission threshold Wok (step S280). When it is determined that the dischargeable electric power Wout is not higher than the permission threshold Wok (NO in step S280), the control unit 90 returns to step S210. In this case, the step-up stop flag F remains in the prohibition state.

The dischargeable electric power Wout can increase as a result of, for example, an increase in secondary battery temperature. Therefore, when the dischargeable electric power Wout has increased and there is a decreased possibility of a rapid voltage drop due to an overdischarge of the secondary battery 40, the control unit 90 cancels the prohibition of the step-up stop mode of the secondary battery step-up converter 50.

When it is determined in step S280 that the dischargeable electric power Wout is higher than the permission threshold Wok (YES in step S280), the control unit 90 sets the step-up stop flag F to the permission state (step S290). That is, while the step-up stop mode of the secondary battery step-up converter 50 is prohibited, when the dischargeable electric power Wout becomes higher than the permission threshold Wok, the control unit 90 cancels the prohibition of the step-up stop mode. After step S290, the control unit 90 returns to step S210.

In the present embodiment, the dischargeable electric power Wout corresponds to a subordinate concept of the correlation value in SUMMARY, the condition that the dischargeable electric power Wout is lower than the prohibition threshold Wng corresponds to a subordinate concept of the condition that the correlation value falls within a prohibition range in SUMMARY, and the condition that the dischargeable electric power Wout is higher than the permission threshold Wok corresponds to a subordinate concept of the condition that the correlation value falls within a permission range in SUMMARY.

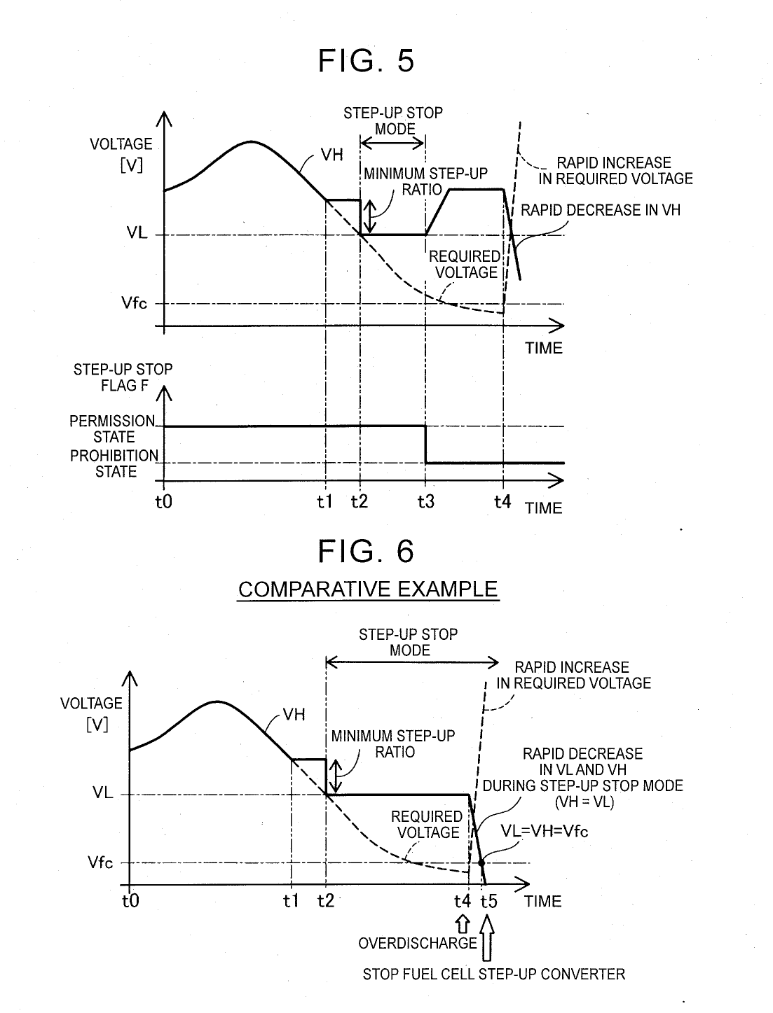

FIG. 5 shows graphs that illustrate an example of a variation in voltage of the secondary battery 40 and a change of the flag. In FIG. 5, the ordinate axis of the top graph represents a voltage (V), the ordinate axis of the bottom graph represents the status of the step-up stop flag F, and the abscissa axis represents time. In FIG. 5, a fuel cell voltage Vfc representing the output voltage of the fuel cell 20 and a secondary battery voltage VL representing the output voltage of the secondary battery 40 each are indicated by the alternate long and short dashes line, a required voltage of the loads 70 including the drive motor 72 is indicated by the chain line, and an inverter voltage VH that is input to the inverter 60 is indicated by the continuous line.

In the example of FIG. 5, the required voltage takes a local high point between time t0 and time t1, and then gradually decreases until time t4 with passage of time. Since the required voltage is higher than the secondary battery voltage VL during the period from time t0 to time t2, the control unit 90 steps up the secondary battery voltage VL to the inverter voltage VH by causing the secondary battery step-up converter 50 to perform step-up operation. If a difference between the primary-side voltage and secondary-side voltage of the secondary battery step-up converter 50 is small, the step-up operation is instable and, as a result, the accuracy of step-up operation deteriorates. For this reason, a minimum step-up ratio is set for the secondary battery step-up converter 50. Since a difference between the required voltage and the secondary battery voltage VL is smaller than the minimum step-up ratio during the period from time t1 to time t2, the secondary battery step-up converter 50 performs step-up operation with the minimum step-up ratio.

Since the dischargeable electric power Wout of the secondary battery 40 is higher than the permission threshold Wok of the step-up stop mode during the period from time t0 to time t3 (YES in step S250 and NO in step S260 in FIG. 2), the step-up stop flag F is set to the permission state. Therefore, as the required voltage becomes lower than the secondary battery voltage VL at time t2, the control unit 90 permits the upper arm on state of the secondary battery step-up converter 50, that is, permits the step-up stop mode. Thus, the inverter voltage VH becomes equal to the secondary battery voltage VL.

As the dischargeable electric power Wout of the secondary battery 40 becomes lower than the prohibition threshold Wng of the step-up stop mode at time t3 due to a decrease in SOC, a decrease or increase in secondary battery temperature, or the like (YES in step S260 of FIG. 2), the step-up stop flag F is set to the prohibition state (step S270 of FIG. 2). Thus, even in a state where the required voltage is lower than the secondary battery voltage VL, the upper arm on state of the secondary battery step-up converter 50 is prohibited, that is, the step-up stop mode is prohibited. Thus, the secondary battery step-up converter 50 steps up the primary-side voltage (VL) to the secondary-side voltage (VH) with the minimum step-up ratio or a step-up ratio higher than the minimum step-up ratio. Therefore, the inverter voltage VH becomes higher than the secondary battery voltage VL.

In the example of FIG. 5, at time t4, the required voltage of the loads 70, such as the drive motor 72, rapidly increases as a result of, for example, a slip or grip of the fuel cell vehicle. If the required voltage has rapidly increased in this way, adjustment of the output electric power of the fuel cell 20 with the fuel cell step-up converter 30 does not keep pace with a rapid increase in the required voltage, with the result that an electric power that is supplied from the fuel cell 20 side can run short and the inverter voltage VH can decrease. However, in the example of FIG. 5, the step-up stop mode of the secondary battery step-up converter 50 is prohibited at time t3, and, after time t3, the step-up operation of the secondary battery step-up converter 50 is maintained also at time t4. As a result, the secondary battery voltage VL is kept, and, even when the inverter voltage VH decreases from time t4, a decrease in the inverter voltage VH to the fuel cell voltage Vfc is suppressed. Therefore, a situation in which the primary-side voltage (Vfc) and secondary-side voltage (VH) of the fuel cell step-up converter 30 are equal to each other is avoided as much as possible, and a stop of the fuel cell step-up converter 30 is avoided as much as possible.

With the fuel cell system 10 according to the present embodiment, the control unit 90 prohibits the step-up stop mode of the secondary battery step-up converter 50 when the required voltage of the loads 70, such as the drive motor 72, is lower than the secondary battery voltage VL and the dischargeable electric power Wout of the secondary battery 40 is lower than the prohibition threshold Wng of the step-up stop mode. That is, when the dischargeable electric power Wout is lower than the prohibition threshold Wng, the step-up stop mode is prohibited even when the required voltage is lower than the secondary battery voltage VL. For this reason, it is possible to prohibit the step-up stop mode of the secondary battery step-up converter 50 when there is a possibility of an overdischarge of the secondary battery 40. Therefore, when the required voltage of the loads 70 has rapidly increased, it is possible to avoid a rapid drop of the secondary battery voltage VL and inverter voltage VH due to an overdischarge of the secondary battery 40 resulting from directly coupling the secondary battery step-up converter 50. For this reason, it is possible to avoid as much as possible a situation in which the primary-side voltage (Vfc) and secondary-side voltage (VH) of the fuel cell step-up converter 30 are equal to each other, so it is possible to avoid as much as possible a stop of the fuel cell step-up converter 30. Therefore, it is possible to reduce electric power consumption while avoiding as much as possible a situation in which the output electric power of the fuel cell 20 is not adjustable. It is also possible to avoid as much as possible a situation in which the output electric power of the fuel cell step-up converter 30 is not adjustable and, as a result, the required voltage cannot be supplied. In addition, it is possible to reduce degradation of the secondary battery 40 resulting from continuous supply of an electric power higher than or equal to the rated dischargeable electric power of the secondary battery 40 from the secondary battery 40.

The control unit 90 cancels the prohibition of the step-up stop mode when the dischargeable electric power Wout becomes higher than the permission threshold Wok while the step-up stop mode of the secondary battery step-up converter 50 is prohibited. For this reason, for example, when there is a decreased possibility of an overdischarge of the secondary battery 40 resulting from an increase in dischargeable electric power Wout due to an increase in secondary battery temperature, or the like, it is possible to further reduce electric power consumption of the secondary battery step-up converter 50 by permitting the step-up stop mode of the secondary battery step-up converter 50, so it is possible to further reduce a loss in the loads 70 or the auxiliaries 80. Therefore, it is possible to further reduce the total electric power consumption of the fuel cell system 10.

Since the control unit 90 prohibits the step-up stop mode when the dischargeable electric power Wout is lower than the prohibition threshold Wng, and cancels the step-up stop mode when the dischargeable electric power Wout becomes higher than the permission threshold Wok higher than the prohibition threshold Wng. In comparison with a configuration that the prohibition threshold Wng and the permission threshold Wok are equal to each other, it is possible to reduce hunting.

Since the control unit 90 obtains the dischargeable electric power Wout with the secondary battery temperature and the SOC that significantly influence the dischargeable electric power Wout, it is possible to suppress a decrease in the accuracy of calculating the dischargeable electric power Wout. Since the control unit 90 determines whether to prohibit or permit the step-up stop mode with the dischargeable electric power Wout that directly correlates with an overdischarge of the secondary battery 40, it is possible to prohibit the step-up stop mode in accurately keeping with the dischargeable electric power of the secondary battery 40.

### B. Comparative Example

FIG. 6 is a graph that illustrates an example of a voltage drop of a secondary battery in a fuel cell system according to a comparative example. In FIG. 6, the ordinate axis represents a voltage (V), and the abscissa axis represents time. In FIG. 6, the fuel cell voltage Vfc and the secondary battery voltage VL each are indicated by the alternate long and short dashes line, the required voltage of loads including a drive motor is indicated by the chain line, and the inverter voltage VH is indicated by the continuous line.

In the fuel cell system according to the comparative example, a step-up stop mode of a secondary battery step-up converter is not prohibited. Therefore, a control unit definitely stops the step-up operation mode of the secondary battery step-up converter when the required voltage of the loads is lower than the secondary battery voltage VL. In FIG. 6, at time t2 at which the required voltage of the loads becomes lower than the secondary battery voltage VL, the step-up operation of the secondary battery step-up converter is stopped. Therefore, during the period from time t2 to time t4, the inverter voltage VH and the secondary battery voltage VL are equal to each other.

As the required voltage of the loads rapidly increases due to, for example, a slip or grip of the fuel cell vehicle at time t4, since the secondary battery step-up converter is in the step-up stop mode, an overdischarge of the secondary battery occurs, so the secondary battery voltage VL and the inverter voltage VH rapidly drop. Therefore, as the secondary battery voltage VL and the inverter voltage VH decrease until the secondary battery voltage VL and the inverter voltage VH become equal to the fuel cell voltage Vfc at time t5, the primary-side voltage (Vfc) and secondary-side voltage (VH) of the fuel cell step-up converter become equal to each other, so the fuel cell step-up converter stops.

In contrast, since the fuel cell system 10 according to the present embodiment prohibits the step-up stop mode of the secondary battery step-up converter 50 by executing the step-up stop control when there is a possibility of a rapid voltage drop due to an overdischarge of the secondary battery 40, it is possible to avoid as much as possible a situation in which the primary-side voltage (Vfc) and secondary-side voltage (VH) of the fuel cell step-up converter 30 are equal to each other, so it is possible to avoid as much as possible a stop of the fuel cell step-up converter 30.

### C. Alternative Embodiments

### C-1. First Alternative Embodiment

In the above-described embodiment, determination is carried out with the prohibition threshold Wng and the permission threshold Wok; however, the disclosure is not limited to this configuration. For example, instead of the prohibition threshold Wng and the permission threshold Wok, determination may be carried out by consulting the maps shown in FIG. 3 and FIG. 4. In this embodiment, when a current dischargeable electric power Wout falls within any one of the prohibition ranges in which the step-up stop mode is prohibited, as indicated by hatching in FIG. 3 and FIG. 4, the step-up stop mode may be prohibited. Similarly, when a current dischargeable electric power Wout falls within a permission range in which the step-up stop mode is permitted, the prohibition of the step-up stop mode may be cancelled. With this configuration as well, similar advantageous effects to those of the above-described embodiment are obtained.

### C-2. Second Alternative Embodiment

In the above-described embodiment, determination is carried out with the prohibition threshold Wng and the permission threshold Wok higher than the prohibition threshold Wng; however, the disclosure is not limited to this configuration. For example, the permission threshold Wok for permitting the step-up stop mode may be omitted, and the prohibition of the step-up stop mode may be maintained even in a situation in which the dischargeable electric power Wout has increased while the step-up stop mode is prohibited. In addition, for example, the prohibition threshold Wng and the permission threshold Wok may be equal to each other. In other words, determination of the step-up stop control may be carried out with a threshold by which the prohibition threshold Wng and the permission threshold Wok are not distinguished from each other. That is, generally, when the required voltage of the loads 70 is lower than the output voltage of the secondary battery 40 and the dischargeable electric power Wout falls within a predetermined prohibition range in which the step-up stop mode is prohibited, the step-up stop mode is prohibited. When the required voltage is lower than the output voltage of the secondary battery 40 and the dischargeable electric power Wout falls outside the prohibition range, the step-up stop mode may be executed. With this configuration as well, similar advantageous effects to those of the above-described embodiment are obtained.

### C-3. Third Alternative Embodiment

In the above-described embodiment, a dischargeable electric power Wout is obtained with a secondary battery temperature and an SOC; however, the disclosure is not limited to this configuration. For example, a dischargeable electric power Wout1 based on only a secondary battery temperature and a dischargeable electric power Wout2 based on only an SOC may be obtained, and determination may be carried out with a prohibition threshold Wng1 and permission threshold Wok1 of the dischargeable electric power Wout1 based on only the secondary battery temperature, and a prohibition threshold Wng2 and permission threshold Wok2 of the dischargeable electric power Wout2 based on only the SOC. With this configuration, in step S260 of the step-up stop control shown in FIG. 2, it may be determined whether at least one of the dischargeable electric powers Wout1, Wout2 is lower than a corresponding one of the prohibition thresholds Wng1, Wng2, or, in step S280, it may be determined whether both the dischargeable electric powers Wout1, Wout2 are higher than the corresponding permission thresholds Wok1, Wok2. With this configuration as well, similar advantageous effects to those of the above-described embodiment are obtained.

### C-4. Fourth Alternative Embodiment

In the above-described embodiment, a dischargeable electric power Wout is obtained by consulting the maps shown in FIG. 3 and FIG. 4 with a secondary battery temperature and an SOC; however, the disclosure is not limited to this configuration. For example, a dischargeable electric power Wout may be obtained by consulting a three-dimensional map that shows the relation among a secondary battery temperature, an SOC, and a dischargeable electric power Wout. For example, a dischargeable electric power Wout may be calculated with only any one of a secondary battery temperature and an SOC. In this case, a parameter that is not used to calculate a dischargeable electric power Wout between a secondary battery temperature and an SOC may be treated as a worst condition. For example, in an embodiment of obtaining a dischargeable electric power Wout with only an SOC, it may be assumed that a secondary battery temperature is low or high and a dischargeable electric power Wout is low. That is, generally, the control unit 90 may obtain a correlation value that correlates with a dischargeable electric power of the secondary battery 40 with at least one of a detected secondary battery temperature and a detected SOC. With this configuration as well, similar advantageous effects to those of the above-described embodiment are obtained. For example, a dischargeable electric power Wout may be obtained with any other parameter that influences a dischargeable electric power Wout, such as a discharge duration of the secondary battery 40, in addition to a secondary battery temperature and an SOC or instead of a secondary battery temperature and an SOC. With this configuration as well, similar advantageous effects to those of the above-described embodiment are obtained.

### C-5. Fifth Alternative Embodiment

In the above-described embodiment, determination is carried out with a dischargeable electric power Wout. Alternatively, determination may be carried out with a secondary battery temperature or an SOC instead of a dischargeable electric power Wout. For example, in an embodiment of carrying out determination with a secondary battery temperature, a prohibition range of a secondary battery temperature, in which the step-up stop mode is prohibited, and a permission range of the secondary battery temperature, in which the step-up stop mode is permitted, based on the map shown in FIG. 3 may be prestored in the main storage device, and determination may be carried out by comparing the ranges with a current secondary battery temperature. The secondary battery temperature in this case corresponds to a subordinate concept of the correlation value in SUMMARY. For example, in an embodiment of carrying out determination with an SOC, an SOC prohibition range in which the step-up stop mode is prohibited and an SOC permission range in which the step-up stop mode is permitted, based on the map shown in FIG. 4 may be prestored in the main storage device, and determination may be carried out by comparing the ranges with a current SOC. The SOC in this case corresponds to a subordinate concept of the correlation value in SUMMARY. For example, the prohibition range of the secondary battery temperature, in which the step-up stop mode is prohibited, may be set to −10° C. or below or 50° C. or above, or the like, and the SOC prohibition range in which the step-up stop mode is prohibited may be set to 30% or lower, or the like. That is, generally, the control unit 90 may obtain a correlation value that correlates with a dischargeable electric power of the secondary battery 40, and may prohibit the step-up stop mode when the required voltage of the loads 70 is lower than the output voltage of the secondary battery 40 and the obtained correlation value falls within the predetermined prohibition range in which the step-up stop mode is prohibited. With this configuration as well, similar advantageous effects to those of the above-described embodiment are obtained.

### C-6. Sixth Alternative Embodiment

In the above-described embodiment, the fuel cell system 10 is used while being mounted on the fuel cell vehicle. Alternatively, the fuel cell system 10 may be mounted on any other mobile object, such as a ship and a robot, instead of a vehicle, and may be used as a stationary fuel cell. With this configuration as well, similar advantageous effects to those of the above-described embodiment are obtained.

The disclosure is not limited to the above-described embodiment. The disclosure may be implemented in various forms without departing from the scope of the disclosure. For example, the technical characteristics of the embodiment, which correspond to the technical characteristics of the aspects described in SUMMARY, may be replaced or combined as needed in order to solve part or all of the above-described inconvenience or in order to achieve part or all of the above-described advantageous effects. Unless the technical characteristics are not described as indispensable ones in the specification, the technical characteristics may be deleted as needed.

What is claimed is:

1. A fuel cell system comprising:
a fuel cell configured to supply an electric power to a load;
a secondary battery configured to supply an electric power to the load;
a fuel cell step-up converter connected between the fuel cell and the load, the fuel cell step-up converter being configured to step up an output voltage of the fuel cell, the fuel cell step-up converter being configured to adjust an output electric power of the fuel cell;
a secondary battery step-up converter connected between the secondary battery and the load, an output terminal of the secondary battery step-up converter and an output terminal of the fuel cell step-up converter being electrically connected to each other, the secondary battery step-up converter being configured to step up an output voltage of the secondary battery; and
a control unit configured to execute control for adjusting the output electric power of the fuel cell with the fuel cell step-up converter and control for switching the secondary battery step-up converter between a step-up operation mode and a step-up stop mode, the control unit being configured to obtain a correlation value that correlates with a dischargeable electric power of the secondary battery, the control unit being configured to, when a required voltage of the load is lower than the output voltage of the secondary battery and the correlation value falls within a predetermined prohibition range in which the step-up stop mode is prohibited, prohibit the step-up stop mode of the secondary battery step-up converter, the control unit being configured to, when the required voltage is lower than the output voltage of the secondary battery and the correlation value falls outside the predetermined prohibition range, execute the step-up stop mode.

2. The fuel cell system according to claim 1, wherein the control unit is configured to, when the correlation value falls within a predetermined permission range that is different from the predetermined prohibition range and in which the step-up stop mode is permitted while the step-up stop mode is prohibited, cancel a prohibition of the step-up stop mode.

3. The fuel cell system according to claim 1, further comprising at least one of a temperature sensor configured to detect a temperature of the secondary battery and an SOC detection unit configured to detect an amount of electric power stored in the secondary battery, wherein the control unit is configured to obtain the correlation value with at least one of the temperature detected by the temperature sensor and the amount of electric power detected by the SOC detection unit.

4. The fuel cell system according to claim 3, wherein the control unit is configured to obtain the correlation value with both the temperature and the amount of electric power stored.

5. The fuel cell system according to claim 3, wherein the control unit is configured to, when the temperature of the secondary battery is higher than a first predetermined value or lower than a second predetermined value or when the amount of electric power stored is lower than a predetermined value, prohibit the step-up stop mode.

6. The fuel cell system according to claim 1, wherein the correlation value is a dischargeable electric power value of the secondary battery.

7. The fuel cell system according to claim 6, wherein the control unit stores a prohibition threshold of the dischargeable electric power value for prohibiting the step-up stop mode of the secondary battery step-up converter and a permission threshold of the dischargeable electric power value for permitting the step-up stop mode.

8. The fuel cell system according to claim 7, wherein the permission threshold is set so as to be higher than the prohibition threshold.

9. A control method for a fuel cell system, comprising:
obtaining a correlation value that correlates with a dischargeable electric power of a secondary battery;
when a required voltage of a load, to which an electric power is supplied from the secondary battery and a fuel cell, is lower than an output voltage of the secondary battery and the correlation value falls within a predetermined prohibition range in which a step-up stop mode of a secondary battery step-up converter is prohibited, prohibiting the step-up stop mode, the secondary battery step-up converter being connected between the secondary battery and the load, an output terminal of the secondary battery step-up converter and an output terminal of a fuel cell step-up converter being electrically connected to each other, the secondary battery step-up converter being configured to step up the output voltage of the secondary battery, the fuel cell step-up converter being connected between the fuel cell and the load, the fuel cell step-up converter being configured to step up an output voltage of the fuel cell, the fuel cell step-up converter being configured to adjust an output electric power of the fuel cell; and
when the required voltage is lower than the output voltage of the secondary battery and the correlation value falls outside the predetermined prohibition range, executing the step-up stop mode of the secondary battery step-up converter.
